(19) United States
(12) Patent Application Publication
(10) Pub. No.: US 2022/0101747 A1
(43) Pub. Date: Mar. 31, 2022

(54) METHODS, SYSTEMS, APPARATUSES, AND DEVICES FOR FACILITATING PROVISIONING AN IMPLICIT CURRICULUM OF EDUCATION TO STUDENTS

(71) Applicant: Samuel Odunsi, Austin, TX (US)

(72) Inventor: Samuel Odunsi, Austin, TX (US)

(21) Appl. No.: 17/394,187

(22) Filed: Aug. 4, 2021

Related U.S. Application Data
(60) Provisional application No. 63/034,695, filed on Jun. 4, 2020.

(51) Int. Cl. G09B 19/00; G06Q 10/10; G06Q 10/06; G06K 9/62; G06Q 50/20

(52) U.S. Cl. CPC G09B 19/00; G06Q 10/103; G06Q 50/205; G06K 9/6215; G06Q 10/0639

(57) ABSTRACT

A method and system for facilitating provisioning an implicit curriculum of education to students is provided. Further, the method may include a step of analyzing, the two or more of information using at least one machine learning model. Further, the method may include a step of determining, one or more controversial issues of a society associated with the geographical area based on the analyzing of the two or more of information. Further, the method may include a step of generating, two or more of research topics for two or more of research projects based on the determining. Further, the method may include a step of storing, using a storage device, the two or more of research projects.

The current application claims a priority to the U.S. Provisional Patent application Ser. No. 63/034,695 filed on Jun. 4, 2020.

### FIELD OF THE INVENTION

Generally, the present disclosure relates to the field of data processing. More specifically, the present disclosure relates to methods, systems, apparatuses, and devices for facilitating provisioning an implicit curriculum of education to students.

### BACKGROUND OF THE INVENTION

The field of data processing is technologically important to several industries, business organizations, and/or individuals. In particular, the use of data processing is prevalent for provisioning an implicit curriculum of education to students.

Existing techniques for facilitating provisioning an implicit curriculum of education to students are deficient with regard to several aspects. For instance, current technologies do not close a knowledge gap that exists between explicit knowledge and implicit knowledge of an economic model. Furthermore, current technologies do not provide Capstone courses. Moreover, current technologies do not provide forty Capstone courses as the implicit curriculum.

Therefore, there is a need for methods, systems, apparatuses, and devices for facilitating provisioning an implicit curriculum of education to students that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a method for facilitating provisioning an implicit curriculum of education to students, in accordance with some embodiments. The method may include a step of receiving, using a communication device, two or more of information associated with a geographical area from one or more devices. Further, the two or more of information may be associated with a socio-economic model of the geographical area. Further, the method may include a step of analyzing, using a processing device, the two or more of information using one or more machine learning models. Further, the method may include a step of determining, using the processing device, one or more controversial issues of a society associated with the geographical area based on the analyzing of the two or more of information. Further, the method may include a step of generating, using the processing device, two or more of research topics for two or more of research projects based on the determining. Further, the two or more of research projects may be used for the provisioning of the implicit curriculum of the education to the students. Further, the two or more of research projects may be assigned to the students over one or more durations. Further, supervisors may be assigned for supervising the two or more of research projects assigned to the students. Further, the method may include a step of storing, using a storage device, the two or more of research projects.

Further disclosed herein is a system for facilitating provisioning an implicit curriculum of education to students, in accordance with some embodiments. The system may include a communication device, a processing device, and a storage device. Further, the communication device may be configured for performing a step of receiving two or more of information associated with a geographical area from one or more devices. Further, the two or more of information may be associated with a socio-economic model of the geographical area. Further, the processing device may be communicatively coupled with the communication device. Further, the processing device may be configured for performing a step of analyzing the two or more of information using one or more machine learning models. Further, the processing device may be configured for performing a step of determining one or more controversial issues of a society associated with the geographical area based on the analyzing of the two or more of information. Further, the processing device may be configured for performing a step of generating two or more of research topics for two or more of research projects based on the determining. Further, the two or more of research projects may be used for the provisioning of the implicit curriculum of the education to the students. Further, the two or more of research projects may be assigned to the students over one or more durations. Further, supervisors may be assigned for supervising the two or more of research projects assigned to the students. Further, the storage device may be communicatively coupled with the processing device. Further, the storage device may be configured for performing a step of storing the two or more of research projects.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a block diagram of a computing device for implementing the methods disclosed herein, in accordance with some embodiments.

FIG. 3 is a flow chart of a method for facilitating provisioning an implicit curriculum of education to students, in accordance with some embodiments.

FIG. 4 is a flow chart of a method for facilitating provisioning an implicit curriculum of education to students in which the method further includes identifying a research project from two or more of research projects for the student based on an analyzing of a student data, in accordance with some embodiments.

FIG. 5 is a flow chart of a method for facilitating provisioning an implicit curriculum of education to students in which the method further includes storing an evaluation of a previous project report, in accordance with some embodiments.

FIG. 6 is a flow chart of a method for facilitating provisioning an implicit curriculum of education to students in which the method further includes storing a preliminary evaluation of a previous project report, in accordance with some embodiments.

FIG. 7 is a flow chart of a method for facilitating provisioning an implicit curriculum of education to students in which the method further includes generating at least one enrichment project based on an integrating, in accordance with some embodiments.

FIG. 8 is a flow chart of a method for facilitating provisioning an implicit curriculum of education to students in which the method further includes storing a preliminary evaluation of a previous project report, in accordance with some embodiments.

FIG. 9 is a flow chart of a method for facilitating provisioning an implicit curriculum of education to students in which the method further includes storing a student data, wherein an analyzing of the student data comprises analyzing of a cognitive maturity, in accordance with some embodiments.

FIG. 10 is a flow chart of a method for facilitating provisioning an implicit curriculum of education to students in which the method further includes identifying a supervisor from two or more of supervisors for each research project of two or more of research projects based on a determining of a similarity, in accordance with some embodiments.

FIG. 11 is a block diagram of a system for facilitating provisioning an implicit curriculum of education to students, in accordance with some embodiments.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of facilitating provisioning an implicit curriculum of education to students, embodiments of the present disclosure are not limited to use only in this context.

The Implicit Curriculum of the Economic Model is a curriculum of formal education that supplies its graduates with the knowledge required to maximize the use of technical knowledge for economic development. Implicit knowledge of the economic model is indispensable for continuous and efficient economic growth, the type enjoyed by developed countries and their diaspora. Without implicit knowledge, technical knowledge is expressed rigidly and is not creatively adapted by managers for contingent real world challenges. As a result, underdevelopment has remained persistent in many so-called developing countries despite widespread and increasing formal education attainment. Until now, implicit knowledge has been exclusively supplied via opaque cultural mechanisms with no means to systematically impart it with formal education. The Implicit Curriculum decisively addresses this limitation of formal education. Its graduates will provide the leadership required for sustainable development immediately upon graduation, not at some unknown future date.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

Overview

According to some embodiments, a method to facilitate provisioning implicit curriculum of higher education, in accordance with some embodiments. The method may include obtaining information, using a communication device, from a plurality of sources related a research geographical area. Further, the method may include categorizing the information, using the processing device, into one or more predetermined categories. Further, the method may include analyzing, using a processing device, the categorized information to identify one or more controversial topics in each of the one or more predetermined categories. Further, the method may include determining, using the processing device, a faculty supervisor for each of the one or more controversial topics. Further, the method may include assigning, using the communication device, a predetermined number of the one or more controversial topics (or research projects) to at least one student. Further, the method may include receiving from the at least one student, using the communication device, a research report (or written presentation) related to a controversial topic (research project) assigned to at least one student. Further, the method may include transmitting, using the communication, the research report to the corresponding faculty supervisor. Further, the faculty supervisor may then review the research report and assign a grade to the corresponding student.

In some embodiments, the disclosed methods may facilitate connecting explicit knowledge of the economic model to its implicit knowledge in the curriculum.

In some embodiments, the disclosed methods may facilitate assigning projects that are policy related and address a current controversial issue in society under the broad categories of business, national security, immigration, governance and policy making, freedom and human rights, health, environment, science, and technology.

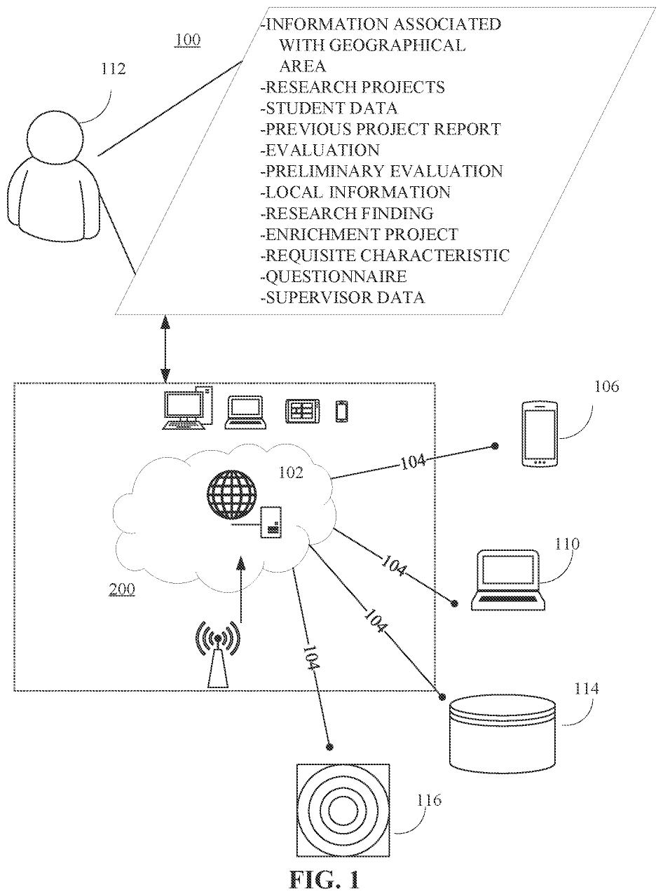

FIG. 1 is an illustration of an online platform 100 consistent with various embodiments of the present disclosure. By way of non-limiting example, the online platform 100 to enable facilitating provisioning an implicit curriculum of education to students may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114, and sensors 116 over a communication network 104, such as, but not limited to, the Internet. Further, users of the online platform 100 may include relevant parties such as, but not limited to, end-users, administrators, service providers, service consumers and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 200.

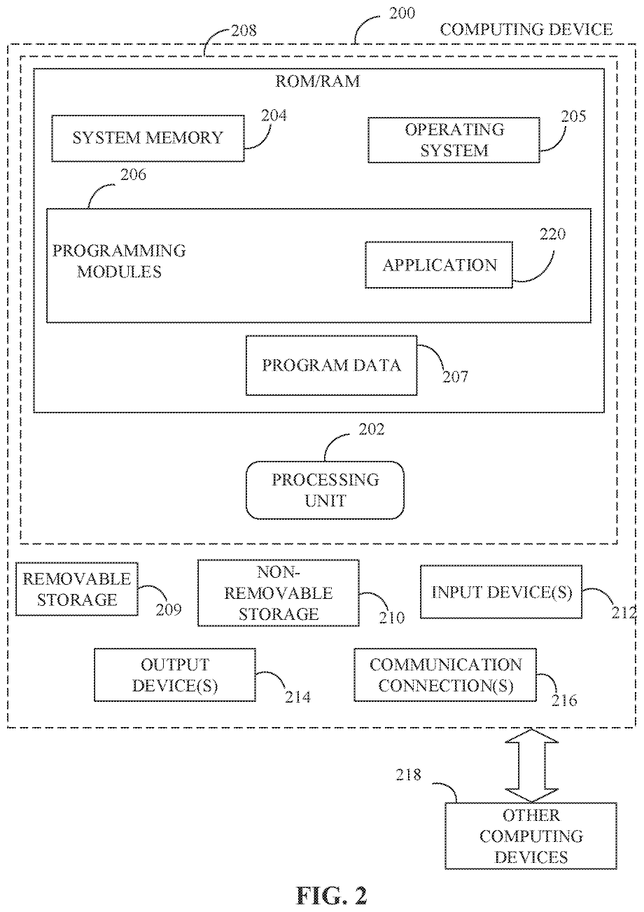

With reference to FIG. 2, a system consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but is not limited to, volatile (e.g. random-access memory (RAM)), non-volatile (e.g. read-only memory (ROM)), flash memory, or any combination. System memory 204 may include operating system 205, one or more programming modules 206, and may include a program data 207. Operating system 205, for example, may be suitable for controlling computing device 200's operation. In one embodiment, programming modules 206 may include image-processing module, machine learning module. Furthermore, embodiments of the disclosure may be practiced in conjunction with a graphics library, other operating systems, or any other application program and is not limited to any particular application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices are examples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, databases as described above. The aforementioned process is an example, and processing unit 202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

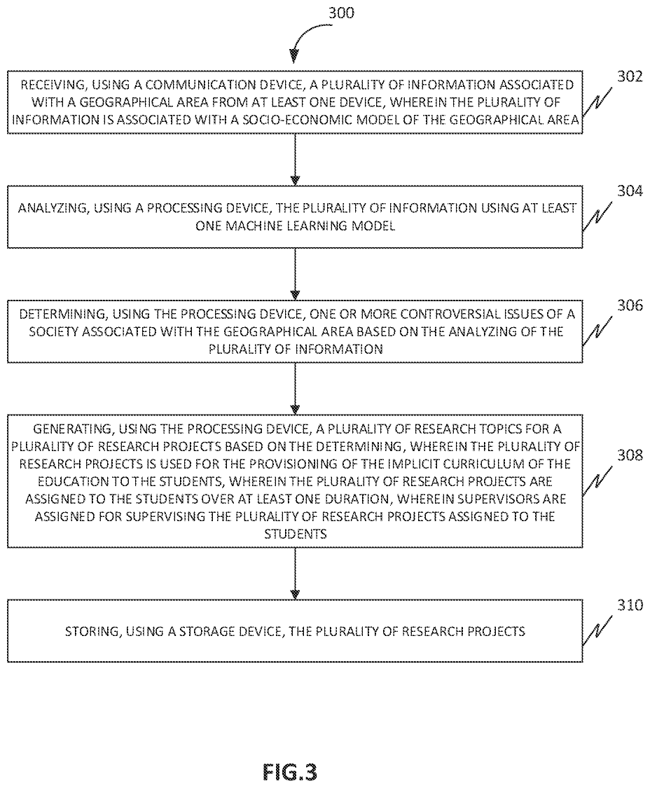

FIG. 3 is a flow chart of a method 300 for facilitating provisioning an implicit curriculum of education to students, in accordance with some embodiments.

At 302, the method 300 may include receiving, using a communication device, two or more of information associated with a geographical area from one or more devices. Further, the two or more of information may be associated with a socio-economic model of the geographical area. Further, the geographical area may include a country, a region, a state, a county, etc.

At 304, the method 300 may include analyzing, using a processing device, the two or more of information using one or more machine learning models.

At 306, the method 300 may include determining, using the processing device, one or more controversial issues of a society associated with the geographical area based on the analyzing of the two or more of information.

At 308, the method 300 may include generating, using the processing device, two or more of research topics for two or more of research projects based on the determining. Further, the two or more of research projects may be used for the provisioning of the implicit curriculum of the education to the students. Further, the two or more of research projects may be assigned to the students over one or more durations. Further, supervisors may be assigned for supervising the two or more of research projects assigned to the students. In some embodiments, the two or more of research projects may include forty capstone quality research projects. Further, the one or more durations may include at most four years.

At 310, the method 300 may include storing, using a storage device, the two or more of research projects.

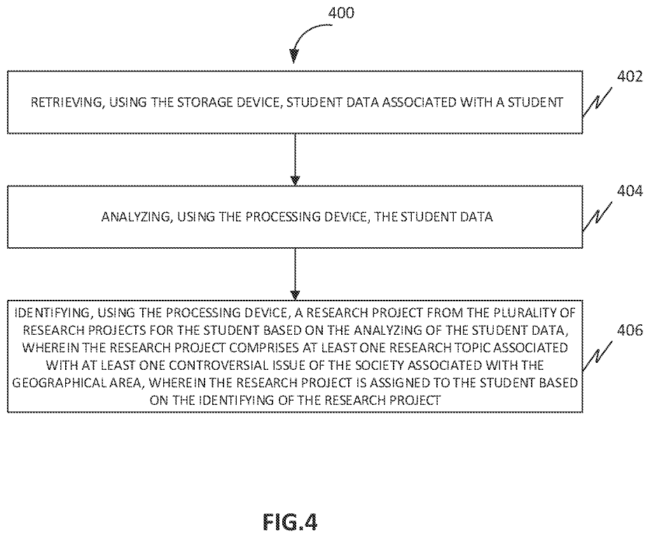

FIG. 4 is a flow chart of a method 400 for facilitating provisioning an implicit curriculum of education to students in which the method 400 further includes identifying a research project from two or more of research projects for the student based on an analyzing of a student data, in accordance with some embodiments.

Further, at 402, the method 400 may include retrieving, using the storage device, student data associated with a student. Further, the student data may include any data associated with the student.

Further, at 404, the method 400 may include analyzing, using the processing device, the student data.

Further, at 406, the method 400 may include identifying, using the processing device, a research project from the two or more of research projects for the student based on the analyzing of the student data. Further, the research project may include one or more research topics associated with one or more controversial issues of the society associated with the geographical area. Further, the research project may be assigned to the student based on the identifying of the research project.

In some embodiments, the student data may include one or more previous research topics of one or more previous research projects completed by the student. Further, the analyzing of the student data may include analyzing the one or more previous research topics. Further, the identifying of the research project may be further based on the analyzing of the one or more previous research topics. Further, the one or more research topics of the research project may be different from the one or more previous research topics.

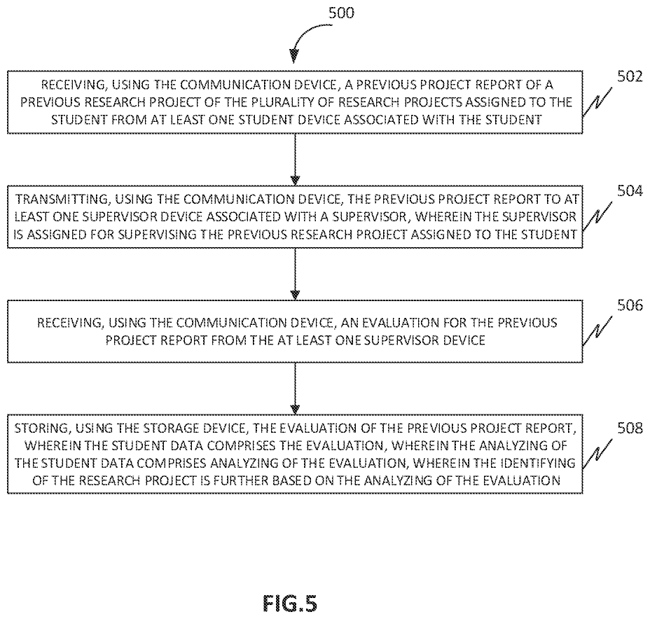

FIG. 5 is a flow chart of a method 500 for facilitating provisioning an implicit curriculum of education to students in which the method 500 further includes storing an evaluation of a previous project report, in accordance with some embodiments.

Further, at 502, the method 500 may include receiving, using the communication device, a previous project report of a previous research project of the two or more of research projects assigned to the student from one or more student devices associated with the student.

Further, at 504, the method 500 may include transmitting, using the communication device, the previous project report to one or more supervisor devices associated with a supervisor. Further, the supervisor may be assigned for supervising the previous research project assigned to the student.

Further, at 506, the method 500 may include receiving, using the communication device, an evaluation for the previous project report from the one or more supervisor devices.

Further, at 508, the method 500 may include storing, using the storage device, the evaluation of the previous project report. Further, the student data may include the evaluation. Further, the analyzing of the student data may include analyzing of the evaluation. Further, the identifying of the research project may be further based on the analyzing of the evaluation.

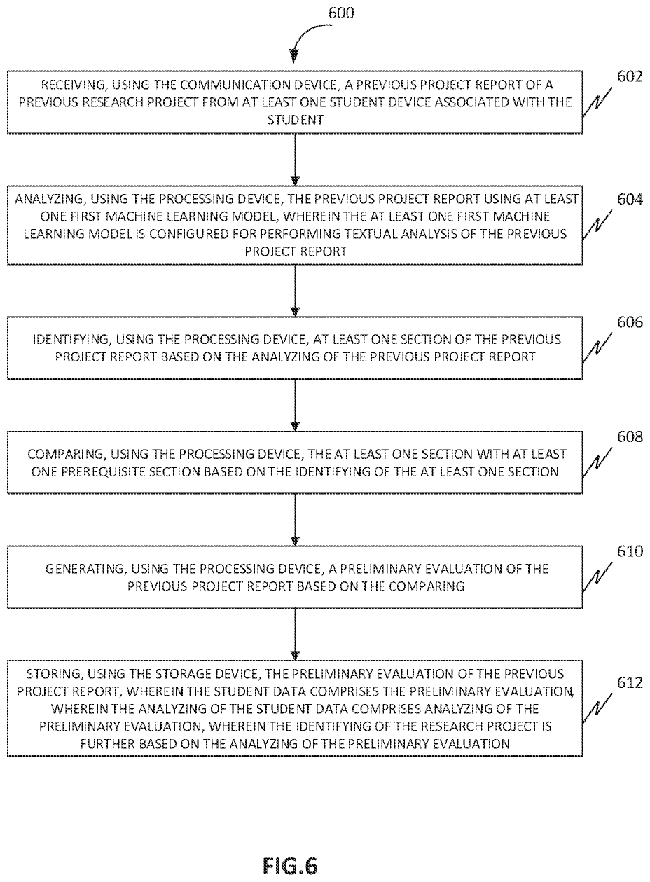

FIG. 6 is a flow chart of a method 600 for facilitating provisioning an implicit curriculum of education to students in which the method 600 further includes storing a preliminary evaluation of a previous project report, in accordance with some embodiments.

Further, at 602, the method 600 may include receiving, using the communication device, a previous project report of a previous research project from one or more student devices associated with the student.

Further, at 604, the method 600 may include analyzing, using the processing device, the previous project report using one or more first machine learning models. Further, the one or more first machine learning models may be configured for performing textual analysis of the previous project report.

Further, at 606, the method 600 may include identifying, using the processing device, one or more sections of the previous project report based on the analyzing of the previous project report. Further, the one or more sections may include a literature review section of a background of the one or more controversial issues, at least one of a historical aspect, a legal aspect, a political aspect, a moral aspect, a scientific aspect, and a technological aspect of the one or more controversial issues, a critique section comprising of one or more positions held by one or more parties to the one or more controversial issues.

Further, at 608, the method 600 may include comparing, using the processing device, the one or more sections with one or more prerequisite sections based on the identifying of the one or more sections. Further, the one or more prerequisite sections may include any sections of the previous project report that may be required to be present in the previous project report. Further, the one or more prerequisite sections may include a literature review section of a background of the one or more controversial issues, at least one of a historical aspect, a legal aspect, a political aspect, a moral aspect, a scientific aspect, and a technological aspect of the one or more controversial issues, a critique section comprising of one or more positions held by one or more parties to the one or more controversial issues.

Further, at 610, the method 600 may include generating, using the processing device, a preliminary evaluation of the previous project report based on the comparing.

Further, at 612, the method 600 may include storing, using the storage device, the preliminary evaluation of the previous project report. Further, the student data may include the preliminary evaluation. Further, the analyzing of the student data may include analyzing of the preliminary evaluation. Further, the identifying of the research project may be based on the analyzing of the preliminary evaluation.

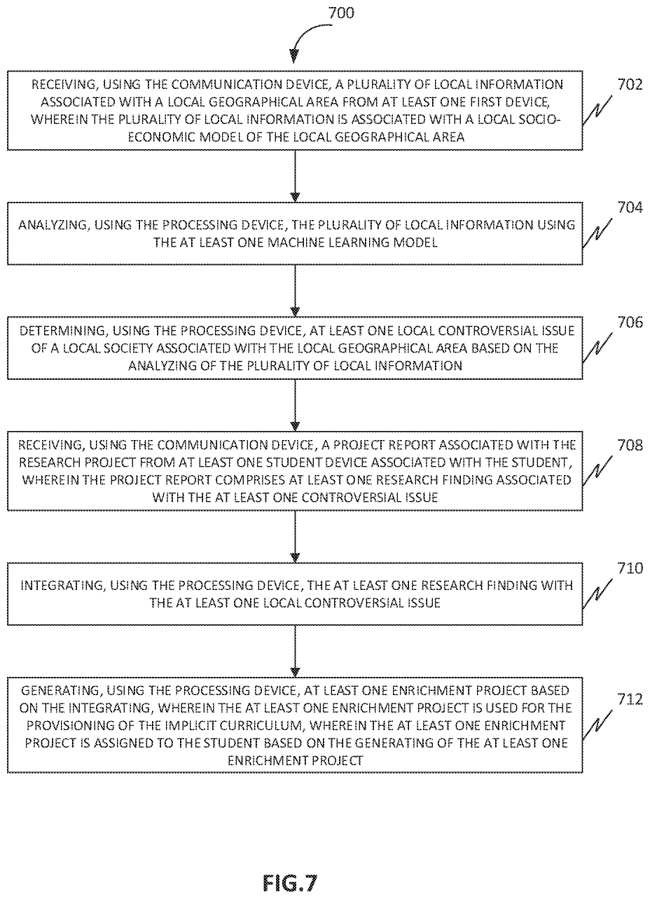

FIG. 7 is a flow chart of a method 700 for facilitating provisioning an implicit curriculum of education to students in which the method 700 further includes generating at least one enrichment project based on an integrating, in accordance with some embodiments.

Further, at 702, the method 700 may include receiving, using the communication device, two or more of local information associated with a local geographical area from one or more first devices. Further, the two or more of local information may be associated with a local socio-economic model of the local geographical area. Further, the local geographical area may include a country, a region, a state, a county, etc.

Further, at 704, the method 700 may include analyzing, using the processing device, the two or more of local information using the one or more machine learning models.

Further, at 706, the method 700 may include determining, using the processing device, one or more local controversial issues of a local society associated with the local geographical area based on the analyzing of the two or more of local information.

Further, at 708, the method 700 may include receiving, using the communication device, a project report associated with the research project from one or more student devices associated with the student. Further, the project report may include one or more research findings associated with the one or more controversial issues.

Further, at 710, the method 700 may include integrating, using the processing device, the one or more research findings with the one or more local controversial issues.

Further, at 712, the method 700 may include generating, using the processing device, one or more enrichment projects based on the integrating. Further, the one or more enrichment projects may be used for the provisioning of the implicit curriculum. Further, the one or more enrichment projects may be assigned to the student based on the generating of the one or more enrichment projects.

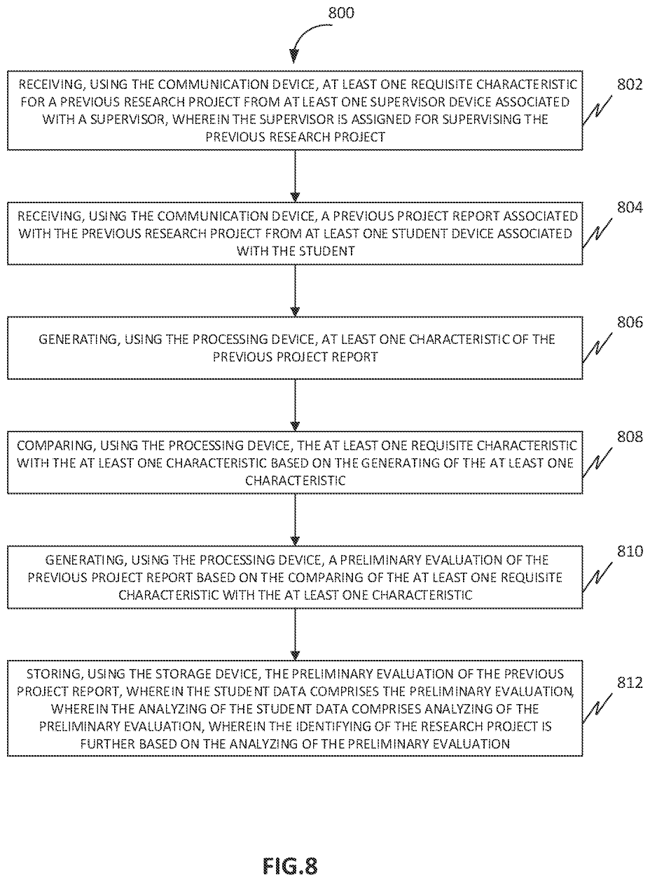

FIG. 8 is a flow chart of a method 800 for facilitating provisioning an implicit curriculum of education to students in which the method 800 further includes storing a preliminary evaluation of a previous project report, in accordance with some embodiments.

Further, at 802, the method 800 may include receiving, using the communication device, one or more requisite characteristics for a previous research project from one or more supervisor devices associated with a supervisor. Further, the supervisor may be assigned for supervising the previous research project. Further, the one or more requisite characteristics may include any characteristic of the previous project report that may be required to be present in the previous project report. Further, the one or more requisite characteristics may include a required submission date, a required submission time, etc. of the previous project report provided by the supervisor.

Further, at 804, the method 800 may include receiving, using the communication device, a previous project report associated with the previous research project from one or more student devices associated with the student.

Further, at 806, the method 800 may include generating, using the processing device, one or more characteristics of the previous project report. Further, the one or more characteristics may include an actual submission date, an actual submission time, etc. of the previous project report.

Further, at 808, the method 800 may include comparing, using the processing device, the one or more requisite characteristics with the one or more characteristics based on the generating of the one or more characteristics.

Further, at 810, the method 800 may include generating, using the processing device, a preliminary evaluation of the previous project report based on the comparing of the one or more requisite characteristics with the one or more characteristics.

Further, at 812, the method 800 may include storing, using the storage device, the preliminary evaluation of the previous project report. Further, the student data may include the preliminary evaluation. Further, the analyzing of the student data may include analyzing of the preliminary evaluation. Further, the identifying of the research project may be based on the analyzing of the preliminary evaluation.

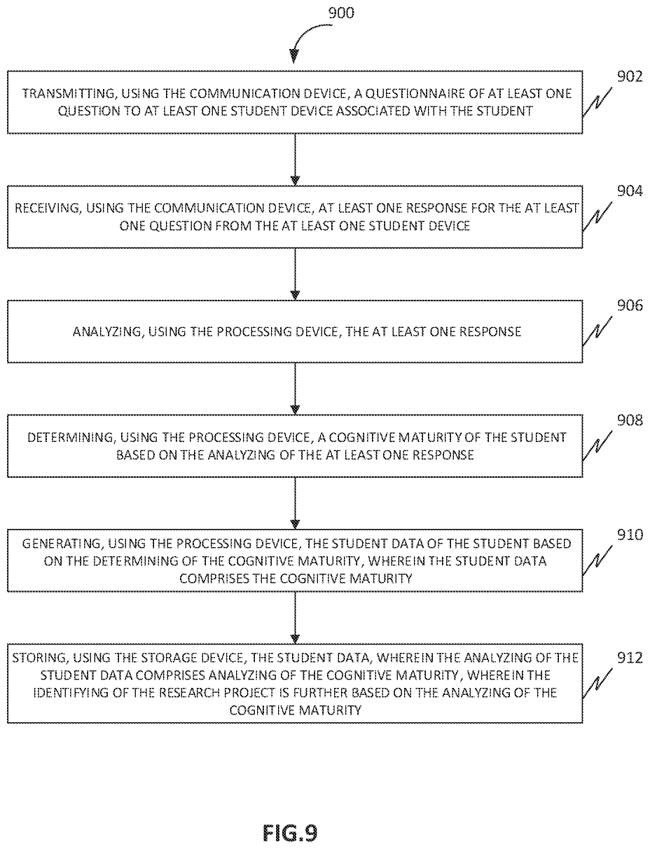

FIG. 9 is a flow chart of a method 900 for facilitating provisioning an implicit curriculum of education to students in which the method 900 further includes storing a student data, wherein an analyzing of the student data comprises analyzing of a cognitive maturity, in accordance with some embodiments.

Further, at 902, the method 900 may include transmitting, using the communication device, a questionnaire of one or more questions to one or more student devices associated with the student.

Further, at 904, the method 900 may include receiving, using the communication device, one or more responses for the one or more questions from the one or more student devices.

Further, at 906, the method 900 may include analyzing, using the processing device, the one or more responses.

Further, at 908, the method 900 may include determining, using the processing device, a cognitive maturity of the student based on the analyzing of the one or more responses.

Further, at 910, the method 900 may include generating, using the processing device, the student data of the student based on the determining of the cognitive maturity. Further, the student data may include the cognitive maturity.

Further, at 912, the method 900 may include storing, using the storage device, the student data. Further, the analyzing of the student data may include analyzing of the cognitive maturity. Further, the identifying of the research project may be based on the analyzing of the cognitive maturity.

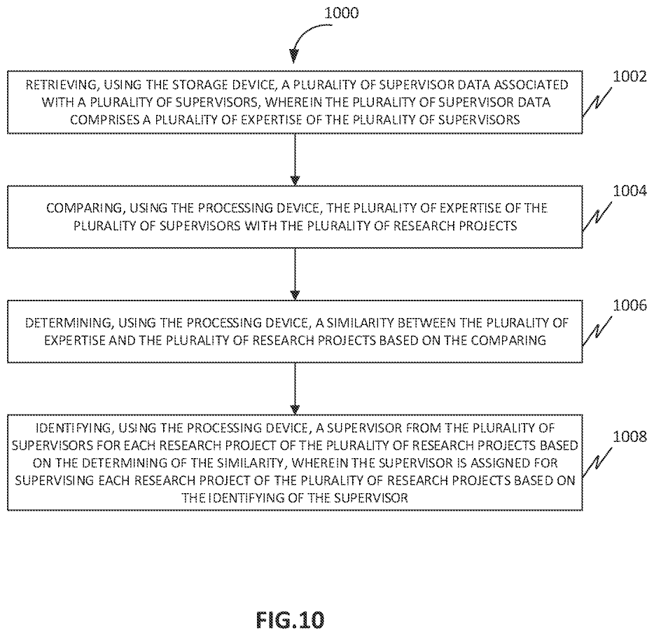

FIG. 10 is a flow chart of a method 1000 for facilitating provisioning an implicit curriculum of education to students in which the method 1000 further includes identifying a supervisor from two or more of supervisors for each research project of two or more of research projects based on a determining of a similarity, in accordance with some embodiments.

Further, at 1002, the method 1000 may include retrieving, using the storage device, two or more of supervisor data associated with two or more of supervisors. Further, the two or more of supervisor data may include two or more of expertise of the two or more of supervisors.

Further, at 1004, the method 1000 may include comparing, using the processing device, the two or more of expertise of the two or more of supervisors with the two or more of research projects.

Further, at 1006, the method 1000 may include determining, using the processing device, a similarity between the two or more of expertise and the two or more of research projects based on the comparing.

Further, at 1008, the method 1000 may include identifying, using the processing device, a supervisor from the two or more of supervisors for each research project of the two or more of research projects based on the determining of the similarity. Further, the supervisor may be assigned for supervising each research project of the two or more of research projects based on the identifying of the supervisor.

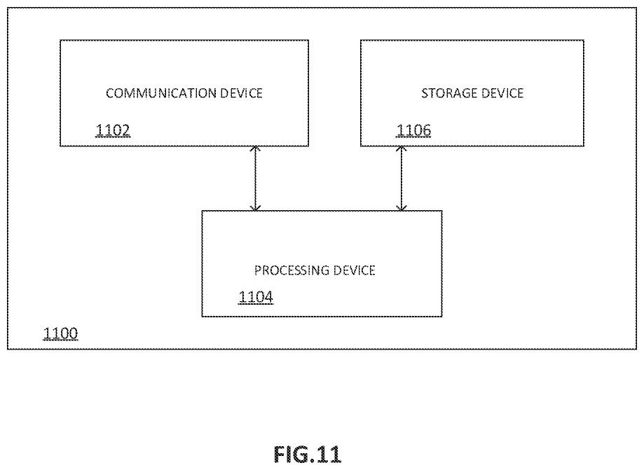

FIG. 11 is a block diagram of a system 1100 for facilitating provisioning an implicit curriculum of education to students, in accordance with some embodiments. The system 1100 may include a communication device 1102, a processing device 1104 and a storage device 1106.

Further, the communication device 1102 may be configured for performing a step of receiving two or more of information associated with a geographical area from one or more devices. Further, the two or more of information may be associated with a socio-economic model of the geographical area.

The processing device 1104 may be communicatively coupled with the communication device 1102.

Further, the processing device 1104 may be configured for performing a step of analyzing the two or more of information using one or more machine learning models.

Further, the processing device 1104 may be configured for performing a step of determining one or more controversial issues of a society associated with the geographical area based on the analyzing of the two or more of information.

Further, the processing device 1104 may be configured for performing a step of generating two or more of research topics for two or more of research projects based on the determining. Further, the two or more of research projects may be used for the provisioning of the implicit curriculum of the education to the students. Further, the two or more of research projects may be assigned to the students over one or more durations. Further, supervisors may be assigned for supervising the two or more of research projects assigned to the students.

The storage device 1106 may be communicatively coupled with the processing device 1104.

Further, the storage device 1106 may be configured for performing a step of storing the two or more of research projects.

In some embodiments, the two or more of research projects may include forty capstone quality research projects, the one or more durations may include at most four years.

In some embodiments, the storage device 1106 may be configured for performing a step of retrieving student data associated with a student. Further, the processing device 1104 may be configured for performing a step of analyzing the student data. Further, the processing device 1104 may be configured for performing a step of identifying a research project from the two or more of research projects for the student based on the analyzing of the student data. Further, the research project may include one or more research topics associated with one or more controversial issues of the society associated with the geographical area. Further, the research project may be assigned to the student based on the identifying of the research project.

In some embodiments, the student data may include one or more previous research topics of one or more previous research projects completed by the student. Further, the analyzing of the student data may include analyzing the one or more previous research topics. Further, the identifying of the research project may be further based on the analyzing of the one or more previous research topics. Further, the one or more research topics of the research project may be different from the one or more previous research topics.

In some embodiments, the communication device 1102 may be configured for performing a step of receiving a previous project report of a previous research project of the two or more of research projects assigned to the student from one or more student devices associated with the student. Further, the communication device 1102 may be configured for performing a step of transmitting the previous project report to one or more supervisor devices associated with a supervisor. Further, the supervisor may be assigned for supervising the previous research project assigned to the student. Further, the communication device 1102 may be configured for performing a step of receiving an evaluation for the previous project report from the one or more supervisor devices. Further, the storage device 1106 may be configured for performing a step of storing the evaluation of the previous project report. Further, the student data may include the evaluation. Further, the analyzing of the student data may include analyzing of the evaluation. Further, the identifying of the research project may be further based on the analyzing of the evaluation.

In some embodiments, the communication device 1102 may be configured for performing a step of receiving a previous project report of a previous research project from one or more student devices associated with the student. Further, the processing device 1104 may be configured for performing a step of analyzing the previous project report using one or more first machine learning models. Further, the one or more first machine learning models may be configured for performing textual analysis of the previous project report. Further, the processing device 1104 may be configured for performing a step of identifying one or more sections of the previous project report based on the analyzing of the previous project report. Further, the processing device 1104 may be configured for performing a step of comparing the one or more sections with one or more prerequisite sections based on the identifying of the one or more sections. Further, the processing device 1104 may be configured for performing a step of generating a preliminary evaluation of the previous project report based on the comparing. Further, the storage device 1106 may be configured for performing a step of storing the preliminary evaluation of the previous project report. Further, the student data may include the preliminary evaluation. Further, the analyzing of the student data may include analyzing of the preliminary evaluation. Further, the identifying of the research project may be based on the analyzing of the preliminary evaluation.

In some embodiments, the communication device 1102 may be configured for performing a step of receiving two or more of local information associated with a local geographical area from one or more first devices. Further, the two or more of local information may be associated with a local socio-economic model of the local geographical area. Further, the communication device 1102 may be configured for performing a step of receiving a project report associated with the research project from one or more student devices associated with the student. Further, the project report may include one or more research findings associated with the one or more controversial issues. Further, the processing device 1104 may be configured for performing a step of analyzing the two or more of local information using the one or more machine learning models. Further, the processing device 1104 may be configured for performing a step of determining one or more local controversial issues of a local society associated with the local geographical area based on the analyzing of the two or more of local information. Further, the processing device 1104 may be configured for performing a step of integrating the one or more research findings with the one or more local controversial issues. Further, the processing device 1104 may be configured for performing a step of generating one or more enrichment projects based on the integrating. Further, the one or more enrichment projects may be used for the provisioning of the implicit curriculum. Further, the one or more enrichment projects may be assigned to the student based on the generating of the one or more enrichment projects.

In some embodiments, the communication device 1102 may be configured for performing a step of receiving one or more requisite characteristics for a previous research project from one or more supervisor devices associated with a supervisor. Further, the supervisor may be assigned for supervising the previous research project. Further, the communication device 1102 may be configured for performing a step of receiving a previous project report associated with the previous research project from one or more student devices associated with the student. Further, the processing device 1104 may be configured for performing a step of generating one or more characteristics of the previous project report. Further, the processing device 1104 may be configured for performing a step of comparing the one or more requisite characteristics with the one or more characteristics based on the generating of the one or more characteristics. Further, the processing device 1104 may be configured for performing a step of generating a preliminary evaluation of the previous project report based on the comparing of the one or more requisite characteristics with the one or more characteristics. Further, the storage device 1106 may be configured for performing a step of storing the preliminary evaluation of the previous project report. Further, the student data may include the preliminary evaluation. Further, the analyzing of the student data may include analyzing of the preliminary evaluation. Further, the identifying of the research project may be based on the analyzing of the preliminary evaluation.

In some embodiments, the communication device 1102 may be configured for performing a step of transmitting a questionnaire of one or more questions to one or more student devices associated with the student. Further, the communication device 1102 may be configured for performing a step of receiving one or more responses for the one or more questions from the one or more student devices. Further, the processing device 1104 may be configured for performing a step of analyzing the one or more responses. Further, the processing device 1104 may be configured for performing a step of determining a cognitive maturity of the student based on the analyzing of the one or more responses. Further, the processing device 1104 may be configured for performing a step of generating the student data of the student based on the determining of the cognitive maturity. Further, the student data may include the cognitive maturity. Further, the storage device 1106 may be configured for performing a step of storing the student data. Further, the analyzing of the student data may include analyzing of the cognitive maturity. Further, the identifying of the research project may be based on the analyzing of the cognitive maturity.

In some embodiments, the storage device 1106 may be configured for performing a step of retrieving two or more of supervisor data associated with two or more of supervisors. Further, the two or more of supervisor data may include two or more of expertise of the two or more of supervisors. Further, the processing device 1104 may be configured for performing a step of comparing the two or more of expertise of the two or more of supervisors with the two or more of research projects. Further, the processing device 1104 may be configured for performing a step of determining a similarity between the two or more of expertise and the two or more of research projects based on the comparing. Further, the processing device 1104 may be configured for performing a step of identifying a supervisor from the two or more of supervisors for each research project of the two or more of research projects based on the determining of the similarity. Further, the supervisor may be assigned for supervising each research project of the two or more of research projects based on the identifying of the supervisor.

Aspects:

PURPOSE: The purpose of the Implicit Curriculum of Higher Education is to connect the explicit knowledge of the economic model to its implicit knowledge, which is the human language faculty. The Implicit Curriculum accomplishes this goal mainly by subjecting the student to 40 research projects over a period of 3 to 4 years using the resources of higher education. Each of the 40 research projects will entail the steps and rigor of a well supervised interdisciplinary capstone course.

ENTRY REQUIREMENTS: The Implicit Curriculum is reserved for higher education mainly because the skills and cognitive maturity of secondary education are required for the demands of the curriculum. In addition, a screening test may be required to determine if the applicant needs remedial and preparatory training to participate. Touch typing skill is required.

RESEARCH PROJECTS: Research projects are to be evenly distributed over the duration of the program with no fewer than 5 projects to be simultaneously undertaken and completed in each of the eight terms or semesters in a 4-year program. More projects per term or more terms per year will be required to complete the 40 courses in a 3-year program. Also, each research project must have a unique faculty supervisor. That is, the same faculty supervisor cannot oversee more than 1 project for a given student in a single semester term.

PROGRAM: The Implicit Curriculum is a full-time residential higher education program that requires the facilities and full resources of local higher education institutions in its establishment and implementation. The Implicit Curriculum is intended to replace in full the existing undergraduate higher education curriculum in the manner that the Trivium (Murphy, J. J. Rhetoric in the Middle Ages: A History of the Rhetorical Theory from Saint Augustine to the Renaissance) constituted general higher education in the Europe of old. A faculty supervised capstone course is usually assigned full class credit of at least 3 hours plus a letter grade (Institutional Effectiveness and Assessment at Skidmore College. https://www.skidmore.edu/assessment/archived/capstone-courses.php. Independent Work in Molecular Biology, A Guide to the JP and Senior Thesis, 2015-2016, p. 14. https://molbio.princeton.edu/sites/molbio/files/documents/2015_6_mol_guide_to_independent_work.pdf). Likewise, each research course in the Implicit Curriculum is to be assigned full class credit plus a letter grade. The completion of the 40 research projects will be the equivalent of the total number of credit hours required to obtain an undergraduate degree in conventional undergraduate programs. Contemporary professional or vocational training in higher education has limited value in a developing country because it goes begging without the managerial leadership that will put it to work. For this reason, professional training is deferred to after the completion of the Implicit Curriculum, in the manner of the Quadrivium (Ibid). Such optional professional training in higher education will then only need to consist of the core curriculum of the vocation, thereby taking a shorter time to complete.

RESEARCH TOPICS. Topics for Implicit Curriculum research projects are policy-related and must address a current controversial issue in society under the broad categories of business, national security, immigration, governance and policy making, freedom and human rights, health, environment, science, technology, and more. Administration of the Implicit Curriculum must ensure that each student covers a diversity of categories with no duplication of topic over the duration of the program. In the course of 40 projects, the student will be required to investigate, analyze, and render executive level decisions in all categories.

RESEARCH AND ANALYSIS: As with standard interdisciplinary capstone courses that are well administered, the analysis and presentation of the topic will assume that the faculty supervisor is unfamiliar with the topic. So, enough information and analysis must be contained in written presentations to convince not only the faculty supervisor that a logical, coherent, and morally acceptable case that meets minimum standards is being made, but also to convince an informed layperson. It is unlikely that a student will be familiar with or have prior knowledge of each controversial subject of research. When a topic is initially unfamiliar to the student, orientation and familiarity will be established by the research steps that include a literature review of the background of the controversy, the historical, legal, political, moral, scientific and technological aspects of the controversy, and a critique of the positions held by parties to the controversy. These findings serve as the bases of the student's analyses. The faculty supervisor then determines whether the accuracy and validity of the factual and subjective aspects of the presentation are acceptable or need revision.

RESEARCH GEOGRAPHIC AREA: All the topics of Implicit Curriculum research projects for a given developing country will concern controversies occurring in a single developed country and analyzed with the goal of implementing the student's conclusion in the developed country. This is the case for one reason that can be stated in the following ways:

1. A developing country is a Western-style economy that isn't working as well as a Western economy or as well as the economies of the few Asian countries that have successfully implemented the Western economic model. Development is the result when the ideas and concepts of the economic model are effectively implemented on a consistent basis and underdevelopment is the result when they are not. Hence, the primary focus of the Implicit Curriculum is on how the economic model works in developed countries, not its improper operation in developing countries.

2. The defining characteristic of persistent underdevelopment is a widespread and permanent shortage of the managerial and entrepreneurial leadership necessary for organizing, maintaining, and increasing the productivity of human capital and material resources as well as the developed countries. Higher education is the incubator for leadership that will implement the economic model as effectively as it is done in developed countries, not how it's ineffectively done in developing countries.

3. The best iteration of economic success for a developing country is the standard seen in developed countries. A developing country is underdeveloped to the degree by which its operation, as a whole and in detail, does not meet the standards of the Western-style economy that it is. The more its operation differs from the standards of the developed countries, the more underdeveloped the country is (Odunsi Sr., Samuel, The Failure of University Education for Development and What to Teach Instead, 2016).

The developed country of choice for the Implicit Curriculum may be determined by the language used locally for conducting higher education. For instance, countries with English as the official language can choose among the English speaking developed countries, and those with French or Spanish as the official language can choose among French or Spanish speaking developed countries.

FACULTY SUPERVISION: The ideal implementation of the Implicit Curriculum requires the faculty supervision of research projects to be performed by faculty members operating in the research geographic area. This will be done through the internet. The duties of the faculty supervisor include all the standard faculty supervisor duties listed for capstone research projects. That may include any and all forms of internet communication. The academics operating in the research geographic area are best situated to effectively guide the ideas and expressions of the student in research projects for consistency with best practices about the economic model in the developed country of choice. This online collaboration by local universities with overseas ones does not preclude the participation of local faculty in ancillary capacities for the Implicit Curriculum. Local faculty must still be available for professional training anyway.

The use of the internet to facilitate faculty supervision by academics in developed countries should not suggest that the Implicit Curriculum is an online course. Again, the Implicit Curriculum is a full-time residential higher education program that requires the facilities and full resources of local higher education institutions in its establishment and implementation. Collaboration with academia in developed countries can be gradually phased out as the graduates of the Implicit Curriculum become available as instructors, after making their mark in the economy and if they choose to participate. The effectiveness of the Implicit Curriculum is not guaranteed if the main faculty supervision duties are provided by local faculty members instead of higher education faculty in developed countries.

ENRICHMENT COURSES: In addition to 40 full-fledged capstone quality research courses, there are also mandatory enrichment courses for the Implicit Curriculum that will be graded by student participation, quizzes, short tests and the completion of moderate homework assignments. Enrichment courses will be held at scheduled class times with the supervision of local faculty members and will last for up to 2 hours per day of school time that could be broken into shorter periods in the school day. Enrichment courses have 3 purposes.

1. Integrate research findings with local issues and practice adaptive and contingent problem solving. Here, the effectiveness, historical origins, purpose, justification, and the moral and legal bases of institutions and organizations in the developed country are compared with their local equivalents in the context of the details of research topics. This will be done mainly in class discussions. Outcome is to cultivate and enhance with local situations the permanent diagnostic perspective of the economic model that the main research program is generating in the student.

2. Focus students' attention inward with reflection activities that may include discussions about the effect of new findings and discoveries by students on their perspectives about the economic model; newly noticed patterns or perceived regularities in the operation of the economic model; the evolution or revolution of previously held views in the face of new information; generate questions that may require further investigation to be discussed in subsequent class meetings, etc.

3. Familiarize students with contemporary knowledge in the natural sciences and mathematics.

4. Enhance practical knowledge and skills including quantitative skills, advanced technological literacy, and communication and leadership skills.

Enrichment courses include guest lectures, video presentations, debates, hands-on projects and activities, and interactive computer simulations.

How the Implicit Curriculum Works

Proof of the effectiveness of the Implicit Curriculum is to be found only in the performance of graduates. That is, how effectively graduates perform when compared to the developed countries and to the expatriates from developed countries that already operate in their midst. Nevertheless, how the Implicit Curriculum works to yield this outcome can be explained with conventional wisdom and what is known about the human language faculty.

CONVENTIONAL EXPLANATIONS OF HOW THE IMPLICIT CURRICULUM WORKS: A single faculty-supervised capstone quality research course requires the student to make one or more executive level decisions that cover different aspects of the economic model, supported by findings in library research and literature review, and vetted by faculty supervision. Each project requires the analysis and synthesis of findings as well as extensive writing. As mentioned, the Association of American Colleges & Universities considers a single well administered capstone project to be “liberal education at its best, helping students become critical thinkers skilled in analysis and argument.” (Association of American Colleges & Universities. “Capstones & Signature Work.” https://www.aacu.org/signaturework). When repeated 40 times for 40 contemporary major topics in the 3 to 4 year duration of the program, the student would have rendered informed executive level decisions on a wide variety of issues and their component elements.

In the process, the student will be exposed to a wide and deep knowledge base of the quantitative and qualitative structure of the economic model, familiarity and practice with how its elements interact, how they should interact, and how they could interact for better outcomes. The student will become familiar with the state-of-the-art in major categories of social institutions and resources in the economic model, how resources are effectively deployed, and how to improvise without adequate resources. This will cause the student to develop instinctive strategies for understanding and navigating the economic model. Over time, a well-founded trust of their own knowledge about the economic model is also developed in students. They will become familiar with their own limitations, and be able to recognize or anticipate gaps in the knowledge they possess for responding to and solving problems in the economic model. They will also be able to postulate much of what they should know even in unfamiliar circumstances and will be armed with the skills to verify the accuracy of their deductions.

Moreover, the Implicit Curriculum also embodies the critical elements of all major learning theories and applies their main premises simultaneously and to the greatest extent over the 3 to 4 years of the higher education program. Examples include:

Socratic Learning (Nelson, L and Brown III, T. K. Socratic Method and Critical Philosophy. Yale University Press, 1949). This theory considers the use of reasoning, logic, and critical thinking as most effective for learning. For each research project in the Implicit Curriculum, the philosophical and moral positions of the parties to a controversy involving technical and policy issues are presented along with relevant historical backgrounds. The details are to be analyzed and synthesized to form a coherent argument in a narrative that terminates with conclusions and recommendations. These exercises in critical thinking, reasoning, and logic are to be repeated over 40 research projects that individually meet the minimum standards of a faculty supervised capstone course.

Behaviorist Learning Theory (Amsel, A. Behaviorism, Neobehaviorism, and Cognitivism in Learning Theory: Historical and Contemporary Perspectives. Lawrence Eribaum Associates, Hillsdale, N J, 1989). This theory rejects internal mental states in favor of environmental stimuli as the determinant of observable human behavior. Fine. For each of the 40 research projects, the Implicit Curriculum requires the student to locate, study, and cite diverse literature and extract and re-express in his or her own written words the origins and history of the controversy and the positions held by opposing sides. This torrent of concentrated stimuli over years of study will significantly expand the student's knowledge base of the economic model and how it works.

Constructivist Learning Theory (Brockbank, A. and McGill, I. Facilitating Reflective Learning in Higher Education. Open University Press, 2007). This theory emphasizes the need to respect individual complexity and uniqueness in the learning process. The Implicit Curriculum does that exceptionally well. The benefits of personalized teaching and learning in education have long been acknowledged and promoted but implemented relatively superficially. Schools still teach and test largely by subject areas as opposed to their synthesis in the real world. Until now, there has been little opportunity to affordably implement individualized learning that is tailored by default to each student like the Implicit Curriculum does. The research and analytical tasks of the Implicit Curriculum and their presentation in writing are active modes of learning. For each research project, the student is required to independently conduct the literature review, analysis, and writing which must meet the minimum standards determined by faculty supervision. In this manner, the student builds their own meanings and mental structures which must be reconciled with prior understanding and beliefs about how the economic model works.

Neurology (Alberini, C. M. Memory Reconsolidation. Elsevier Academic Press, 2013). The Implicit Curriculum is consistent with the neurological concept of “memory consolidation.” The Curriculum requires the student to repetitively and continuously address, over several years, different complex issues and their components, and to resolve them with analyses and logic vetted by faculty supervision. Over time, the student will independently decipher analytical and problem-solving patterns or regularities in the economic model that are generally applicable or that can be strategically deployed or repurposed. The observations are unique to the student and may consist of extensive implicit aspects that cannot be verbalized or explained. This deciphering of patterns is consistent with the neurological premises of “long-term potentiation” and “neural plasticity,” whereby efficient and effective ways of thinking about the economic model are developed and made permanent with repetitive use over the course of the Implicit Curriculum.

While conventional explanations about the workings of the Implicit Curriculum can be elaborated endlessly at great length, they have serious limitations because they're based on conventional wisdom that have trapped human intellect in the status quo.

LANGUAGE FACULTY EXPLANATION OF HOW THE IMPLICIT CURRICULUM WORKS: A program that aims to integrate knowledge of the economic model with the language faculty would ideally cover all known areas of knowledge in depth. But that's not necessary because the Implicit Curriculum relies on the recursive ability of the language faculty to repurpose a relatively small set of internalized examples to interpret new and novel circumstances and to competently administer familiar ones. This aspect of the Implicit Curriculum is comparable with adult acquisition of a foreign language.

The competent use of a foreign language cannot be directly learned or taught. It has to be acquired by the student. As explained by Stephen Kashen, competence in a foreign language “emerges” in the student through the provision of a large amount of “comprehensible input.” This is input about the use of the language that is understood by the student. As that happens, the language faculty automatically provides the grammar that is necessary to competently express the language. With a steady supply of comprehensible input, acquisition becomes “inevitable, unavoidable, and cannot be prevented.” (Krashen, S. D., The Input Hypothesis: Issues and Implications, New York: Longman, 1985, p. 80). The only constraint in this process is that the student must be receptive to learning the language (Ibid, p. 80). But that is not relevant to the Implicit Curriculum because what is being acquired in the Curriculum is not spoken language and the student is already competent in the language of instruction.

Nevertheless, the Implicit Curriculum uses the same process to close the implicit knowledge gap. The Curriculum constantly calls for organizing, analyzing, integrating and synthesizing input about the economic model with what the student already knows about the world. This is then re-expressed to the satisfaction of faculty supervision for the specific objectives of research projects. Hence, the Implicit Curriculum supplies so much comprehensible input for the language faculty over 3 to 4 years that the integration of the implicit and explicit knowledge of the economic model (resonance) is inevitable, unavoidable, and cannot be prevented. The implicit knowledge gap is thereby closed.

A corollary of closing the implicit knowledge gap is that the student has developed a permanent but unconscious diagnostic perspective of the economic model. When we're proficient in a language, we often accurately express thought with speech in that language as fast as it comes to mind and also tend to immediately correct misspoken utterances. We also frequently understand incoming messages that contain unfamiliar or “unacquired grammar” by interpreting them in context (Ibid.). This suggests that the language faculty has diagnostic filtering properties that ensures the correct use of the language at all times. This, in turn, suggests that this unconscious, always-on diagnostic filter consults an internal frame of reference that is accurate for the language. It has been proposed (for a slightly different reason) that such a frame of reference consists of first, knowledge about the language that was explicitly learned by the individual and second, the unconscious knowledge of the proper use of the language supplied by the language faculty (Ibid., p. 79).

It is assumed that a similar unconscious diagnostic filtering mechanism is responsible at the individual level for the spontaneous and accurate expression of the economic model as seen in developed countries and among their expatriate diaspora. But the frame of reference for this filter consists of first, knowledge about the economic model that was explicitly learned by the individual and second, the unconscious knowledge of the effective use of the economic model supplied by the language faculty. When there is no implicit knowledge gap and explicit knowledge is connected to implicit knowledge in the individual, a permanent diagnostic perception or filter of the economic model exists. This filter compels the individual to notice existing and potential problems for the purpose of fixing them and compels the relentless trouble-shooting and problem solving of the economic model as a normal way of being. Coupled with motivational attributes such as ambition, drive, and other personality traits, the diagnostic filter is expressed by individuals as basic to excellent levels of competence in managerial, entrepreneurial, innovative, and creative pursuits. So, even without competitive market pressure, relatively stable systems of infrastructure, administration, and production in developed countries are subject to effective anticipatory maintenance, thanks to the diagnostic perspective. This contrasts with the stagnant entropy of comparable systems in developing countries where expatriates are usually indispensable for their proper maintenance.

### Features of Implicit Curriculum:

1. Implicit Curriculum is NOT online based and is NOT e-learning. Physical class attendance is required daily during the semester because of enrichment courses that all students must attend and which contribute to overall course grading.
2. The central aspect of the Implicit Curriculum consists of research and analysis, and has an 80 to 90 percent weight in grading per semester and for the entire multi-year program. Research and analyses are NOT collaborative. All aspects of research projects, ranging from data gathering, sorting and analyses, are to be conducted individually and independently by the student. Collaboration with others is prohibited, even if the research topic is similar or identical. Enrichment courses have only a 10 to 20 percent weight per semester and for the entire multi-year program. Enrichment courses involve class discussions, and classroom projects that will be observed by all participants. Some of these projects, such as computer business simulations and hands-on building-modelling projects can involve collaboration with other students.
3. Students DO NOT work at their own pace. The pace is set by the submission date for different stages of each project. Faculty supervisor sets the submission dates.
4. Implicit Curriculum is NOT online based. Physical class attendance is required daily during the semester because of enrichment courses that all students must attend and which contribute to overall course grading.
5. There is NO synchronization in student learning. However, submission dates for each step of research projects are the same for every student at the same point in the multi-year program.
6. Research and analyses are NOT collaborative. All aspects of research projects, ranging from data gathering, sorting and analyses, are to be conducted individually and independently by the student. Collaboration with others is prohibited, even if the research topic is similar or identical. Enrichment courses have only a 10 to 20 percent weight per semester and for the entire multi-year program. Enrichment courses involve class discussions, and classroom projects that will be observed by all participants. Some of these projects, such as computer business simulations and hands-on building-modelling projects can involve collaboration with other students.
7. Implicit Curriculum does not have any MOOC to “simulate the feel of a classroom.” There is no login for this purpose.
8. Instructor does NOT construct “online case-study course”
9. Research projects of Implicit Curriculum do NOT engage in learn through peer interaction or “intuition building exercise.” BUT Enrichment courses involve class discussions, and classroom projects that will be observed by all participants. Some of these projects, such as computer business simulations and hands-on building-modelling projects can involve collaboration with other students. Enrichment courses have only a 10 to 20 percent weight per semester and for the entire multi-year program. Enrichment courses involve class discussions, and classroom projects that will be observed by all participants. Implicit Curriculum integrates passive, active, and adaptive learning, NOT by instruction but through the sheer volume of information and analyses in 40 full scale research projects.
10. Implicit Curriculum does NOT involve “a system for performing curriculum planning . . . ” or programmable computer or any other item in listed. But Enrichment courses involve projects, such as computer business simulations and hands-on building-modelling projects.
11. The Implicit Curriculum is NOT a teaching method. It is an Extended LEARNING METHOD that consists primarily of 40 research projects over 3 or 4 years. Instructor only corrects parts of a project (5 or 6 research projects per semester, depending on whether it is 3 or 4 years in duration). But Implicit Curriculum involves “learning knowledge and skills through extended inquiry process structured around complex, rea-life” CONTROVERSIES.
12. Students do NOT “work together in groups” for any part of research projects. There is no “motivation to learn.” Students simply need to independently engage in the research, analysis, and writing of the successive parts of each project and submit them on the dates that are stipulated by faculty supervisor. Research projects make up 80 to 90 percent of the program. They also need to participate in Enrichment Courses that make up 10 to 20 percent. “Teaching Practices” for research projects consist of the traditional steps for Interdisciplinary Capstone courses. “Teaching Practices” for Enrichment Courses involve moderating and supervising in-class activities as outlined in the section of the Patent for Enrichment Courses.
13. Implicit Curriculum research projects do NOT involve input from peers. Input from faculty supervisor is part of evaluation and feedback for each submitted section of each research project.
14. The explicit goals for each research project consist of a literature review of the background of the controversy, the historical, legal, political, moral, scientific and technological aspects of the controversy, and a critique of the positions held by parties to the controversy. These findings serve as the bases of the student's analyses, conclusions, and final recommendations. There is NO white boarding. “Journaling” is not a submission requirement other than bibliographic citations and footnotes for the sources where information is obtained. Formative assessments are part of student submissions for each project and are to be engaged in by the individual student, not by any group.
15. There is NO collaboration in research projects.
16. Student assumes role of executive decision maker for each research project based on reasoning and principles contained in submissions of different steps of each research paper. Literature review and required analyses will supply the background that will establish student comfort with the topic.
17. Forty capstone quality research projects of 3 to 4 years of Implicit Curriculum makes student adaptable and flexible thinker. The sheer volume of research/analyses of Implicit Curriculum surpasses existing project learning programs.
18. Implicit Curriculum is not a “workshop.” It is a series of capstone-like research projects (5 to 6 per semester for 4 or 3 years) that are self-contained and NOT aimed at “advancing PBL in other courses and programs.”
19. Entry requirement for the Implicit Curriculum requires the cognitive maturity of a secondary school graduate that is competent in reading and comprehension. Furthermore, the Implicit Curriculum is NOT aimed at enhancing competence in a profession. It is aimed at improving competence in ALL professions and in the so-called “soft skills” of problem-solving, critical thinking, and general managerial and creative competence.

No one has ever come up with 40 research capstone quality research projects—conducted 5 to 6 times simultaneously—over 4 to 3 years of continuous study to constitute an entire undergraduate program.

While research projects (capstone or otherwise) are traditional, a capstone course is engaged in only ONCE in the final year of undergraduate higher education. Doing it 40 times as a core curriculum is novel and non-obvious.

FACULTY SUPERVISION: The ideal implementation of the Implicit Curriculum requires the faculty supervision of research projects to be performed by faculty members operating in the research geographic area.

But “Collaboration with academia in developed countries can be gradually phased out as the graduates of the Implicit Curriculum become available as instructors, after making their mark in the economy and if they choose to participate.”

The Implicit Curriculum is a full-time residential higher education program that requires the facilities and full resources of local higher education institutions in its establishment and implementation. The Implicit Curriculum is intended to replace in full the existing undergraduate higher education curriculum in the manner that the Trivium (Murphy, J. J. Rhetoric in the Middle Ages: A History of the Rhetorical Theory from Saint Augustine to the Renaissance. University of California Press, Ltd. 2001) constituted general higher education in the Europe of old. A faculty supervised capstone course is usually assigned full class credit of at least 3 hours plus a letter grade. (Institutional Effectiveness and Assessment at Skidmore College. https://www.skidmore.edu/assessment/archived/capstone-courses.php; Independent Work in Molecular Biology, A Guide to the JP and Senior Thesis, 2015-2016, p. 14. https://molbio.princeton.edu/sites/molbio/files/documents/2015_6_mol_guide_to_independent_work.pdf). Likewise, each research course in the Implicit Curriculum is to be assigned full class credit plus a letter grade. The completion of the 40 research projects will be the equivalent of the total number of credit hours required to obtain an undergraduate degree in conventional undergraduate programs. Contemporary professional or vocational training in higher education has limited value in a developing country because it goes begging without the managerial leadership that will put it to work. For this reason, professional training is deferred to after the completion of the Implicit Curriculum, in the manner of the Quadrivium (Ibid). Such optional professional training in higher education will then only need to consist of the core curriculum of the vocation, thereby taking a shorter time to complete.

According to some embodiments a method to facilitate provisioning implicit curriculum of higher education is disclosed.

The method may include obtaining information, using a communication device, from a plurality of sources related a research geographical area. The plurality of sources may include news, research papers, government gazettes, etc.

Further, the method may include categorizing the information, using the processing device, into one or more predetermined categories. Further, the one or more predetermined categories may include two or more of business, national security, immigration, governance and policy making, freedom and human rights, health, environment, science, technology, etc.

Further, the method may include analyzing, using a processing device, the categorized information to identify one or more controversial topics in each of the one or more predetermined categories.

Further, the method may include determining, using the processing device, a faculty supervisor for each of the one or more controversial topics. The faculty supervisor may be selected from a plurality of faculty supervisors preregistered for the implicit supervisor. The faculty supervisor is determined such that that the faculty supervisor is unfamiliar with the topic the one or more controversial topics. This ensures that enough information and analysis is included in written presentations to convince not only the faculty supervisor that a logical, coherent, and morally acceptable case that meets minimum standards is being made, but also to convince an informed layperson.

Further, the method may include assigning, using the communication device, a predetermined number of the one or more controversial topics (or research projects) to at least one student. Further, the assigning may include evenly distributing the research projects over the duration of the implicit program with no fewer than 5 projects to be simultaneously undertaken and completed in each of the eight terms or semesters in a 4-year program. Further, more projects per term or more terms per year may be required to complete the 40 courses in a 3-year program. Also, each research project must have a unique faculty supervisor. That is, the same faculty supervisor cannot oversee more than 1 project for a given student in a single semester term.

Further, the assigning is performed to ensure that each student covers a diversity of categories with no duplication of topic over the duration of the program. In the course of 40 projects, the student will be required to investigate, analyze, and render executive level decisions in all categories.

Further, it is unlikely that a student will be familiar with or have prior knowledge of each controversial subject of research. When a topic is initially unfamiliar to the student, orientation and familiarity will be established by the research steps that include a literature review of the background of the controversy, the historical, legal, political, moral, scientific and technological aspects of the controversy, and a critique of the positions held by parties to the controversy. These findings serve as the bases of the student's analyses.

Further, the method may include receiving from the at least one student, using the communication device, a research report (or written presentation) related to a controversial topic (research project) assigned to at least one student. The research report may be prepared and shared in any file format such as PDF, DOCX, PPTX etc.

Further, the method may include transmitting, using the communication, the research report to the corresponding faculty supervisor. Further, the faculty supervisor may then review the research report and assign a grade to the corresponding student.

Further, the faculty supervisor may then determine whether the accuracy and validity of the factual and subjective aspects of the presentation are acceptable or need revision.

The ideal implementation of the Implicit Curriculum requires the faculty supervision of research projects to be performed by faculty members operating in the research geographic area. This will be done through the internet. The duties of the faculty supervisor include all the standard faculty supervisor duties listed for capstone research projects. That may include any and all forms of internet communication. The academics operating in the research geographic area are best situated to effectively guide the ideas and expressions of the student in research projects for consistency with best practices about the economic model in the developed country of choice. This online collaboration by local universities with overseas ones does not preclude the participation of local faculty in ancillary capacities for the Implicit Curriculum. Local faculty must still be available for professional training anyway.

The use of the internet to facilitate faculty supervision by academics in developed countries should not suggest that the Implicit Curriculum is an online course. Again, the Implicit Curriculum is a full-time residential higher education program that requires the facilities and full resources of local higher education institutions in its establishment and implementation. Collaboration with academia in developed countries can be gradually phased out as the graduates of the Implicit Curriculum become available as instructors, after making their mark in the economy and if they choose to participate. The effectiveness of the Implicit Curriculum is not guaranteed if the main faculty supervision duties are provided by local faculty members instead of higher education faculty in developed countries.

In addition to 40 full-fledged capstone quality research courses, there are also mandatory enrichment courses for the Implicit Curriculum that will be graded by student participation, quizzes, short tests and the completion of moderate homework assignments. Enrichment courses will be held at scheduled class times with the supervision of local faculty members and will last for up to 2 hours per day of school time that could be broken into shorter periods in the school day.

Although the present disclosure has been explained in relation to its preferred embodiment, it is to be understood that many other possible modifications and variations can be made without departing from the spirit and scope of the disclosure.

What is claimed is:

1. A method for facilitating provisioning an implicit curriculum of education to students, the method comprising:
receiving, using a communication device, a plurality of information associated with a geographical area from at least one device, wherein the plurality of information is associated with a socio-economic model of the geographical area;
analyzing, using a processing device, the plurality of information using at least one machine learning model;
determining, using the processing device, one or more controversial issues of a society associated with the geographical area based on the analyzing of the plurality of information;
generating, using the processing device, a plurality of research topics for a plurality of research projects based on the determining, wherein the plurality of research projects is used for the provisioning of the implicit curriculum of the education to the students, wherein the plurality of research projects is assigned to the students over at least one duration, wherein supervisors are assigned for supervising the plurality of research projects assigned to the students; and
storing, using a storage device, the plurality of research projects.

2. The method of claim 1 further comprising:
retrieving, using the storage device, student data associated with a student;
analyzing, using the processing device, the student data; and
identifying, using the processing device, a research project from the plurality of research projects for the student based on the analyzing of the student data, wherein the research project comprises at least one research topic associated with at least one controversial issue of the society associated with the geographical area, wherein the research project is assigned to the student based on the identifying of the research project.

3. The method of claim 2 further comprising:
receiving, using the communication device, a previous project report of a previous research project of the plurality of research projects assigned to the student from at least one student device associated with the student;
transmitting, using the communication device, the previous project report to at least one supervisor device associated with a supervisor, wherein the supervisor is assigned for supervising the previous research project assigned to the student;
receiving, using the communication device, an evaluation for the previous project report from the at least one supervisor device; and
storing, using the storage device, the evaluation of the previous project report, wherein the student data comprises the evaluation, wherein the analyzing of the student data comprises analyzing of the evaluation, wherein the identifying of the research project is further based on the analyzing of the evaluation.

4. The method of claim 2 further comprising:
receiving, using the communication device, a previous project report of a previous research project from at least one student device associated with the student;
analyzing, using the processing device, the previous project report using at least one first machine learning model, wherein the at least one first machine learning model is configured for performing textual analysis of the previous project report;
identifying, using the processing device, at least one section of the previous project report based on the analyzing of the previous project report;
comparing, using the processing device, the at least one section with at least one prerequisite section based on the identifying of the at least one section;
generating, using the processing device, a preliminary evaluation of the previous project report based on the comparing; and
storing, using the storage device, the preliminary evaluation of the previous project report, wherein the student data comprises the preliminary evaluation, wherein the analyzing of the student data comprises analyzing of the preliminary evaluation, wherein the identifying of the research project is further based on the analyzing of the preliminary evaluation.

5. The method of claim 2 further comprising:
receiving, using the communication device, a plurality of local information associated with a local geographical area from at least one first device, wherein the plurality of local information is associated with a local socio-economic model of the local geographical area;
analyzing, using the processing device, the plurality of local information using the at least one machine learning model;
determining, using the processing device, at least one local controversial issue of a local society associated with the local geographical area based on the analyzing of the plurality of local information;
receiving, using the communication device, a project report associated with the research project from at least one student device associated with the student, wherein the project report comprises at least one research finding associated with the at least one controversial issue;
integrating, using the processing device, the at least one research finding with the at least one local controversial issue; and
generating, using the processing device, at least one enrichment project based on the integrating, wherein the at least one enrichment project is used for the provisioning of the implicit curriculum, wherein the at least one enrichment project is assigned to the student based on the generating of the at least one enrichment project.

6. The method of claim 2 further comprising:
receiving, using the communication device, at least one requisite characteristic for a previous research project from at least one supervisor device associated with a supervisor, wherein the supervisor is assigned for supervising the previous research project;
receiving, using the communication device, a previous project report associated with the previous research project from at least one student device associated with the student;
generating, using the processing device, at least one characteristic of the previous project report;
comparing, using the processing device, the at least one requisite characteristic with the at least one characteristic based on the generating of the at least one characteristic;
generating, using the processing device, a preliminary evaluation of the previous project report based on the comparing of the at least one requisite characteristic with the at least one characteristic; and
storing, using the storage device, the preliminary evaluation of the previous project report, wherein the student data comprises the preliminary evaluation, wherein the analyzing of the student data comprises analyzing of the preliminary evaluation, wherein the identifying of the research project is further based on the analyzing of the preliminary evaluation.

7. The method of claim 2 further comprising:
transmitting, using the communication device, a questionnaire of at least one question to at least one student device associated with the student;
receiving, using the communication device, at least one response for the at least one question from the at least one student device;
analyzing, using the processing device, the at least one response;
determining, using the processing device, a cognitive maturity of the student based on the analyzing of the at least one response;
generating, using the processing device, the student data of the student based on the determining of the cognitive maturity, wherein the student data comprises the cognitive maturity; and
storing, using the storage device, the student data, wherein the analyzing of the student data comprises analyzing of the cognitive maturity, wherein the identifying of the research project is further based on the analyzing of the cognitive maturity.

8. The method of claim 2, wherein the student data comprises at least one previous research topic of at least one previous research project completed by the student, wherein the analyzing of the student data comprises analyzing the at least one previous research topic, wherein the identifying of the research project is further based on the analyzing of the at least one previous research topic, wherein the at least one research topic of the research project is different from the at least one previous research topic.

9. The method of claim 1 further comprising:
retrieving, using the storage device, a plurality of supervisor data associated with a plurality of supervisors, wherein the plurality of supervisor data comprises a plurality of expertise of the plurality of supervisors;
comparing, using the processing device, the plurality of expertise of the plurality of supervisors with the plurality of research projects;
determining, using the processing device, a similarity between the plurality of expertise and the plurality of research projects based on the comparing; and
identifying, using the processing device, a supervisor from the plurality of supervisors for each research project of the plurality of research projects based on the determining of the similarity, wherein the supervisor is assigned for supervising each research project of the plurality of research projects based on the identifying of the supervisor.

10. The method of claim 1, wherein the plurality of research projects comprises forty capstone quality research projects, wherein the at least one duration comprises at most four years.

11. A system for facilitating provisioning an implicit curriculum of education to students, the system comprising:
a communication device configured for receiving a plurality of information associated with a geographical area from at least one device, wherein the plurality of information is associated with a socio-economic model of the geographical area;
a processing device communicatively coupled with the communication device, wherein the processing device is configured for:
analyzing the plurality of information using at least one machine learning model;
determining one or more controversial issues of a society associated with the geographical area based on the analyzing of the plurality of information; and
generating a plurality of research topics for a plurality of research projects based on the determining, wherein the plurality of research projects is used for the provisioning of the implicit curriculum of the education to the students, wherein the plurality of research projects is assigned to the students over at least one duration, wherein supervisors are assigned for supervising the plurality of research projects assigned to the students; and
a storage device communicatively coupled with the processing device, wherein the storage device is configured for storing the plurality of research projects.

12. The system of claim 11, wherein the storage device is further configured for retrieving student data associated with a student, wherein the processing device is further configured for:
analyzing the student data; and
identifying a research project from the plurality of research projects for the student based on the analyzing of the student data, wherein the research project comprises at least one research topic associated with at least one controversial issue of the society associated with the geographical area, wherein the research project is assigned to the student based on the identifying of the research project.

13. The system of claim 12, wherein the communication device is further configured for:
receiving a previous project report of a previous research project of the plurality of research projects assigned to the student from at least one student device associated with the student;
transmitting the previous project report to at least one supervisor device associated with a supervisor, wherein the supervisor is assigned for supervising the previous research project assigned to the student; and
receiving an evaluation for the previous project report from the at least one supervisor device, wherein the storage device is further configured for storing the evaluation of the previous project report, wherein the student data comprises the evaluation, wherein the analyzing of the student data comprises analyzing of the evaluation, wherein the identifying of the research project is further based on the analyzing of the evaluation.

14. The system of claim 12, wherein the communication device is further configured for
receiving a previous project report of a previous research project from at least one student device associated with the student, wherein the processing device is further configured for:
analyzing the previous project report using at least one first machine learning model, wherein the at least one first machine learning model is configured for performing textual analysis of the previous project report;
identifying at least one section of the previous project report based on the analyzing of the previous project report;
comparing the at least one section with at least one prerequisite section based on the identifying of the at least one section; and
generating a preliminary evaluation of the previous project report based on the comparing, wherein the storage device is further configured for storing the preliminary evaluation of the previous project report, wherein the student data comprises the preliminary evaluation, wherein the analyzing of the student data comprises analyzing of the preliminary evaluation, wherein the identifying of the research project is further based on the analyzing of the preliminary evaluation.

15. The system of claim 12, wherein the communication device is further configured for:
receiving a plurality of local information associated with a local geographical area from at least one first device, wherein the plurality of local information is associated with a local socio-economic model of the local geographical area; and
receiving a project report associated with the research project from at least one student device associated with the student, wherein the project report comprises at least one research finding associated with the at least one controversial issue, wherein the processing device is further configured for:
analyzing the plurality of local information using the at least one machine learning model;
determining at least one local controversial issue of a local society associated with the local geographical area based on the analyzing of the plurality of local information;
integrating the at least one research finding with the at least one local controversial issue; and
generating at least one enrichment project based on the integrating, wherein the at least one enrichment project is used for the provisioning of the implicit curriculum, wherein the at least one enrichment project is assigned to the student based on the generating of the at least one enrichment project.

16. The system of claim 12, wherein the communication device is further configured for:
receiving at least one requisite characteristic for a previous research project from at least one supervisor device associated with a supervisor, wherein the supervisor is assigned for supervising the previous research project; and
receiving a previous project report associated with the previous research project from at least one student device associated with the student, wherein the processing device is further configured for:
generating at least one characteristic of the previous project report;
comparing the at least one requisite characteristic with the at least one characteristic based on the generating of the at least one characteristic; and
generating a preliminary evaluation of the previous project report based on the comparing of the at least one requisite characteristic with the at least one characteristic, wherein the storage device is further configured for storing the preliminary evaluation of the previous project report, wherein the student data comprises the preliminary evaluation, wherein the analyzing of the student data comprises analyzing of the preliminary evaluation, wherein the identifying of the research project is further based on the analyzing of the preliminary evaluation.

17. The system of claim 12, wherein the communication device is further configured for:
transmitting a questionnaire of at least one question to at least one student device associated with the student; and
receiving at least one response for the at least one question from the at least one student device, wherein the processing device is further configured for
analyzing the at least one response;
determining a cognitive maturity of the student based on the analyzing of the at least one response; and
generating the student data of the student based on the determining of the cognitive maturity, wherein the student data comprises the cognitive maturity, wherein the storage device is further configured for storing the student data, wherein the analyzing of the student data comprises analyzing of the cognitive maturity, wherein the identifying of the research project is further based on the analyzing of the cognitive maturity.

18. The system of claim 12, wherein the student data comprises at least one previous research topic of at least one previous research project completed by the student, wherein the analyzing of the student data comprises analyzing the at least one previous research topic, wherein the identifying of the research project is further based on the analyzing of the at least one previous research topic, wherein the at least one research topic of the research project is different from the at least one previous research topic.

19. The system of claim 11, wherein the storage device is further configured for retrieving a plurality of supervisor data associated with a plurality of supervisors, wherein the plurality of supervisor data comprises a plurality of expertise of the plurality of supervisors, wherein the processing device is further configured for:
comparing the plurality of expertise of the plurality of supervisors with the plurality of research projects;
determining a similarity between the plurality of expertise and the plurality of research projects based on the comparing; and
identifying a supervisor from the plurality of supervisors for each research project of the plurality of research projects based on the determining of the similarity, wherein the supervisor is assigned for supervising each research project of the plurality of research projects based on the identifying of the supervisor.

20. The system of claim 11, wherein the plurality of research projects comprises forty capstone quality research projects, wherein the at least one duration comprises at most four years.
